(19) United States
(12) Patent Application Publication
(10) Pub. No.: US 2016/0123017 A1
(43) Pub. Date: May 5, 2016

(54) WINDOW SUNLIGHT-SHIELDING DEVICE

(71) Applicant: Zenjiro HONDA, Osaka (JP)

(72) Inventor: Zenjiro HONDA, Shizyounawate-shi (JP)

(73) Assignee: MAHBEX CO. LTD., Higashiosaka-shi, Osaka (JP)

(21) Appl. No.: 14/776,784

(22) PCT Filed: Jan. 21, 2015
(86) PCT No.: PCT/JP2015/051439

§ 371 Date: Jan. 7, 2016

(30) Foreign Application Priority Data
Jan. 27, 2014 (JP) 2014-012228

(51) Int. Cl. E04F 10/06; E06B 9/92; E06B 9/42; E06B 9/44

(52) U.S. Cl. CPC E04F 10/0614; E06B 9/44; E04F 10/0685; E04F 10/0666; E06B 9/92; E06B 9/42

(57) ABSTRACT

There is provided a solar shading device for window that can set the window shading area minimum, ventilate a space between a rolling screen and a window, and have inexpensive and simple structure. The solar shading device for window includes a rolling screen installed at an upper portion of a window on the outdoor side of a building. An upper end of the rolling screen being fixed to a winding shaft biased in a winding direction by a biasing means. A lower end of the rolling screen is supported by a support shaft. One ends of a pair of arms are coupled to respective ends of the support shaft so as for the pair of arm to be disposed on planes perpendicular to the axis of the support shaft. The other ends of the pair of arms are fixed to respective sides of the window on the outdoor side via hinges capable of holding the arms at a desired rotational angle.

### TECHNICAL FIELD

The present invention relates to a solar shading device for window, which includes a rolling screen on the outdoor side of a window of a building to shade solar radiation.

### BACKGROUND ART

The thermal insulating performance of apartment buildings and independent houses has been increasingly improved to reduce heat transfer from the interior to the outside. For this reason, energy for heating during winter has been saved. However, due to heat from solar radiation through windows and heat spontaneously generated indoors, the temperature of the interior becomes too high, leading to increased power consumption of cooling equipment during summer and excessive rise of room temperature even during spring and autumn. With such improvement of the thermal insulating performance of houses, demand for decreasing heat from solar radiation through windows has been grown.

In Japan, a “rattan blind” has been often used to shade solar radiation through a window. However, because the rattan blind hangs near the window, it prevents the view of the outside from an opening, and does not fit for the design of Western-style houses in recent years, becoming less popular. In place of the rattan blind, a rolling screen conventionally used indoors has also been used outdoors. Like the “rattan blind”, the external rolling screen prevents the view of the outside from an opening. Thus, when the external rolling screen is attached to a window of a veranda or a deck, the lower end of the rolling screen is moved forward from the window and is fixed to a handrail or the like of the veranda or the deck, thereby generating a space between the rolling screen and the window to improve the view through the window as well as ventilation into the interior when the window opened. However, to fix the rolling screen to the forward position, the structure such as the handrail in front of the window is required. In addition, the commercial rolling screens have unique designs independent of outer walls of buildings, possibly impairing appearances of the buildings.

Recently, an external blind other than the “rattan blind” and the external rolling screen has been used as a solar shading device. However, because the external blind is installed near a window, when directly receiving solar heat, a metal or plastic blind is heated, and radiant heat from the blind having a high surface temperature disadvantageously raises the indoor temperature.

Further, the solar shading device for window shades solar radiation, but disadvantageously obstructs view of the outside from indoors. To improve the outside view while keeping the solar shading effect, it is preferred to freely set a window shading area minimum while shading solar radiation according to the height of sunlight.

For example, Patent Document 1 discloses a solar shading device for window in which guide rails are vertically provided on both outdoor sides of a window, and a lateral pair of simultaneously moving sliders that lift along the guide rails to vertically move a screen are provided on the guide rails so as to be stoppable at a desired lifted position with a stopper, and at a stopped position of the sliders, the lower end of the screen is movable by a desired distance in the forward/rearward direction of the window.

An awning is one of well-known solar shading devices for window. The awning is configured such that a solar shading sheet is pushed forward from the upper portion of a window with an extendable arm fixed to the upper portion of the window.

### PRIOR ART DOCUMENT

### Patent Document

Patent Document 1: Japanese Patent Laid-open Publication No. 2005-273314

### SUMMARY OF THE INVENTION

### Problems to be Solved by the Invention

However, the device disclosed in Patent Document 1 has a very complicated structure, resulting in high costs. For the awning, when wind hits against the window, the solar shading sheet at the upper portion of the window receives a wind pressure and thus, the arm must have such a high strength as to be endurable against the wind pressure.

In consideration of the problems of the conventional techniques, an object of the present invention is to provide a solar shading device for window that can set the window shading area minimum, ventilate the space between the rolling screen and the window, and have an inexpensive and simple structure.

### Solutions to the Problems

The present invention provides a solar shading device for window including a rolling screen installed at an upper portion of a window on the outdoor side of a building, an upper end of the rolling screen being fixed to a winding shaft biased in a winding direction by a biasing means, and a lower end of the rolling screen being allowed to be pulled down from the winding shaft to cause the rolling screen to shade the window. The lower end of the rolling screen is supported by a support shaft. One ends of a pair of arms are coupled to respective ends of the support shaft so as for the pair of arm to be disposed on planes perpendicular to the axis of the support shaft. The other ends of the pair of arms are fixed to respective sides of the window on the outdoor side via hinges capable of holding the arms at a desired rotational angle. The support shaft is allowed to vertically be moved below the winding shaft to rotate the arms about the hinges along arcs having a radius equal to the length of the arms, and to cause the rolling screen to be held at a desired position so as to spring out of the window.

According to the present invention, by vertically moving the support shaft coupled to the arms to rotate the arms fixed via the hinges, the rolling screen can be lifted to a desired position while keeping a predetermined distance between the lower end of the rolling screen and the window face, and held there.

Preferably, the hinges are torque hinges. Thus, when wind is blowing, the arms can be rotated depending on wind pressure applied to the rolling screen, causing the winding shaft to wind the rolling screen. Therefore, the rolling screen can bear large wind pressure, and the arms need not bear the large wind pressure applied to the rolling screen, and will be durable even with a low strength.

Preferably, an application force of distal ends of the arms due to torques of the torque hinges is 1.1 to 5 times larger than a winding force acting on the rolling screen due to the biasing means. Thus, the arms can efficiently spring the lower end of the rolling screen out of the window.

Preferably, a cleaning element having a length equal to the width of the rolling screen is attached at a winding port of a case for accommodating the winding shaft at the upper end of the rolling screen, and is brought into contact with the rolling screen when the rolling screen is wound and unwound to remove stains adhered to the rolling screen. Thus, the aesthetic appearance of the rolling screen can be kept at all times.

The same pattern as a pattern of an outer wall of the building is printed on the rolling screen. Thereby, the rolling screen fuses into the building, keeping the aesthetic appearance of the building.

### EFFECTS OF THE INVENTION

The solar shading device of the present invention, with simple configuration, can spring the rolling screen out of the window at a desired position, and hold the rolling screen there. For this reason, a space between the rolling screen and the window can be adjusted to efficiently discharge heat in the space, and to address with the solar radiation angle, readily preventing an increase in the room temperature at low costs. In addition, the position of the rolling screen can be set according to the height of sunlight such that the window shading area becomes minimum. Therefore, optimum lighting, view, and solar shading can be achieved depending on seasons and weathers.

### BRIEF DESCRIPTION OF THE DRAWINGS

FIG. 1 is an overall perspective view illustrating a solar shading device in accordance with an embodiment of the present invention.

FIG. 2 is a vertical sectional plan view partially illustrating the solar shading device in accordance with the embodiment of the present invention.

FIG. 3 is an enlarged view partially illustrating the solar shading device in accordance with the embodiment of the present invention in the case where arms are attached to torque hinges.

FIG. 4 is a vertical sectional plan view partially illustrating the solar shading device in accordance with the embodiment of the present invention in the case where the arms are rotated from the wall face by 180 degrees.

FIG. 5 is an enlarged view partially illustrating the solar shading device in accordance with the embodiment of the present invention in the case where the arm is attached to the torque hinge.

FIG. 6 is an enlarged view partially illustrating the solar shading device in accordance with the embodiment of the present invention in the case where the arm is attached to the torque hinge, and the arm is not rotated from the wall face.

FIG. 7 is an enlarged view partially illustrating the solar shading device in accordance with the embodiment of the present invention in the case where the arm is attached to the torque hinge, and the arm is rotated from the wall face by 180 degrees.

### EMBODIMENTS OF THE INVENTION

Each item of an embodiment of the present invention will be described below with reference to figures.

1. Structure of Upper End of Rolling Screen

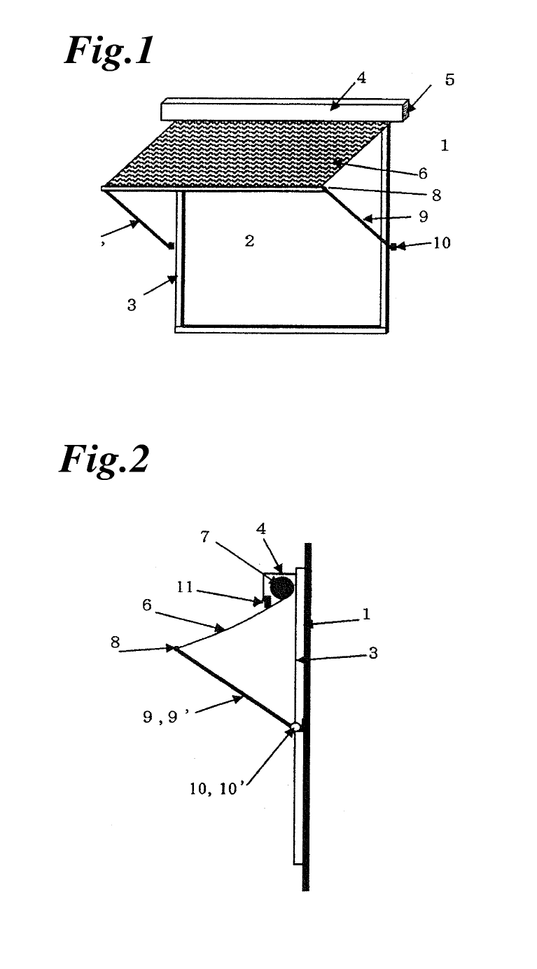

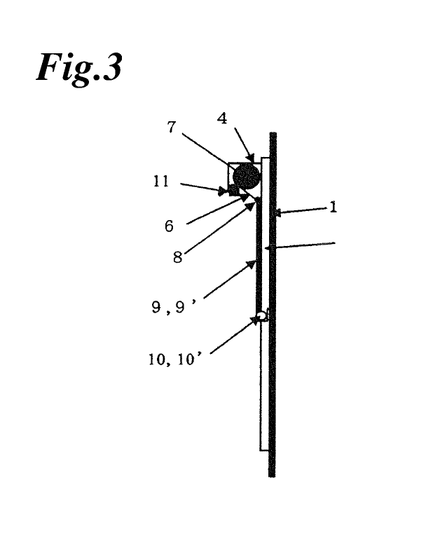

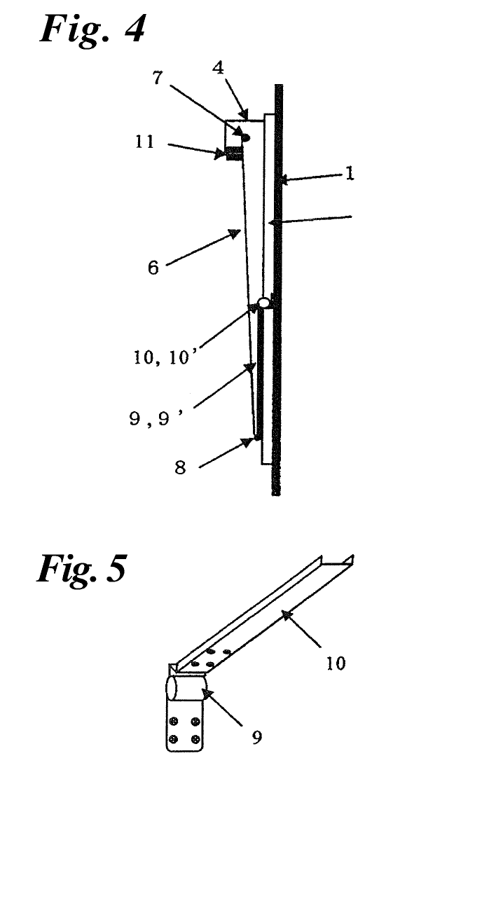

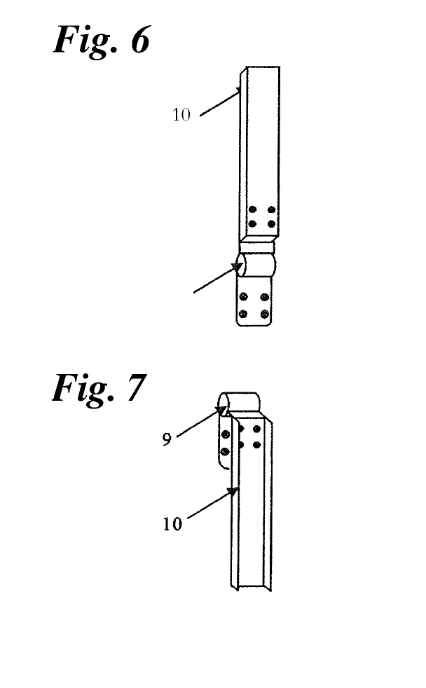

As illustrated in FIGS. 1 and 2, in a solar shading device according to the present invention, an upper end of a rolling screen 6 installed on an upper portion of a window frame 3 on the outdoor side of a building is fixed to a winding shaft 7 biased with biasing means in a winding direction, and a lower end of the rolling screen 6 is pulled down from the winding shaft 7 to shade solar radiation through a window.

The rolling screen 6 is accommodated in a horizontally-long rolling screen case 4 having a feed opening on its lower face, and the winding shaft 7 is rotatably mounted at rolling screen case side plates 5 on both sides of the rolling screen case 4. One end of a biasing member such as a flatwise spring as biasing means are fixed to each protruding end of the winding shaft 7, and the other end is fixed to each of the rolling screen case side plates 5. The flatwise spring contracts while the rolling screen 6 is wound up and extends while the rolling screen 6 is pulled down, and the winding shaft 7 is biased in the winding direction by the biasing members such that the rolling screen 6 is would up at all times.

The rolling screen 6 may be made of any material that can shade solar radiation and be wound around the winding shaft 7, but is preferably made of a sheet material having properties including weatherability, watertightness, and incombustibility. In addition, the rolling screen 6 may completely shield light or partially pass visible light therethrough.

An outer wall of the building may be photographed, and the photograph may be printed on a plain rolling screen by a large format printer. Then, the printed rolling screen may be used as the rolling screen 6.

The commercial or conventionally proposed rolling screens are designed irrespective of the design of the outer wall of the building, largely impairing the aesthetic appearance of the building to give unpleasantness and even disgust to viewers. Thus, the rolling screens have not commonly been used in spite of their solar radiation shading effect.

The rolling screen on which the same pattern as the pattern of the outer wall is printed can fuse into the building, and satisfactorily keep the residential thermal environment by the solar shading effect while maintaining the aesthetic appearance of the building. Such processing of the rolling screen applied to the outer wall of the building can be said to be an innovative idea firstly proposed in this specification.

In addition, as illustrated in FIG. 2, a cleaning element 11 such as a brush, which is slightly larger than the rolling screen in width, is fixedly attached to a roll winding port of the rolling screen case 4 such that the rolling screen 6 is brought into contact with the cleaning element 11 at winding and unwinding to remove stains. Thereby, the rolling screen that can be contaminated with wind and rain and auto emissions can be made permanently clean.

2. Structure of Lower End of Rolling Screen

As illustrated in FIGS. 1 and 2, the lower end of the rolling screen 6 is supported by a support shaft 8.

The support shaft 8 is configured of an aluminum extruded member and plastic end caps, but the material for the support shaft may be made of iron, stainless, plastic, wood, or others other than the aluminum extruded member. The sectional shape of the support shaft may be circle, rectangle, modifications thereof, or others as long as the lower end of the rolling screen 6 can be attached to the support shaft.

One ends of pair of arms 9, 9′ are coupled to both respective ends of the support shaft 8 so as to be disposed on planes perpendicular to the axis of the support shaft.

The support shaft 8 and the arms 9 may be detachably coupled to each other with screws, bolts, rivets, or others, or may be integrally formed.

The other ends of the pair of arms 9, 9′ are fixed to both sides of the window on the outdoor side via torque hinges 10, 10′ that are hinges capable of holding the arms at a desired rotational angle.

As illustrated in FIGS. 2 and 5, the torque hinges 10 that are hinges capable of holding the arms at the desired rotational angle are fixed to middle portion of both sides of the window frame 3 on the outdoor side directly or by means of fixtures. Gear motors may also be used as the hinges other than the torque hinges.

The torque hinges 10 may be configured in any manner as long as an application force of the arm's distal ends can fall within the above-mentioned range, but friction-type torque hinges are inexpensive and preferable.

As illustrated in FIG. 5, the other ends of the arms 9 are connected to the torque hinges 10 capable of holding the arms at the desired rotational angle.

The arms 9 each are configured of an aluminum extruded member having a C-shaped cross section. The arms 9 may be L-shaped or pipe-shaped, and may be made of iron, stainless, or plastic. The length of each of the arms 9 is preferably a height of the window or less and one third of the height of the window or more.

The arms can be rotated about the respective hinges by 0 to 180 degrees, and be held at a desired angle.

3. Operation of Solar Shading Device for Window

With the solar shading device of the present invention, by vertically moving the support shaft 8 below the winding shaft, the arms 9, 9′ are rotated about the torque hinges 10, 10′ as hinges along arcs having a radius equal to the length of the arms, and the rolling screen 6 is held at a desired position so as to spring out of the window.

Here, the application force of the distal ends of the pair of arms 9, 9′, which is caused by torques of the torque hinges 10, 10′ located on both sides of the window, is preferably, 1.1 to 5 times and more preferably, 1.1 to 2 times larger than a winding force acting on the rolling screen 6 due to the biasing means. When the application force of the arm distal ends is smaller than 1.1 times of the winding force acting on the rolling screen 6 due to the biasing means, the rolling screen 6 is wound up by application of only a small force. When the application force of the arm distal ends is larger than 5 times of the winding force acting on the rolling screen due to the biasing means, a large force is required to pull down the lower end of the rolling screen. Further, at receipt of wind, when the application force is large, the rolling screen can bear large wind pressure. However, because of a large load being applied to the arms, the arms must have a higher strength.

Because the winding force acting on the rolling screen 6 due to the biasing means is constant irrespective of the drawing length of the screen, the torque value of the torque hinges, that is, the application force of the arm distal ends can be set in the above-mentioned range relatively readily.

The user can vertically push the support shaft 8 with hands, thereby vertically moving the support shaft 8 below the winding shaft. However, a cord, a handle, or the like may be attached to the support shaft 8, or an operational rod may be attached to the support shaft 8 to vertically move the support shaft 8 from indoors, thereby rising/lowering the rolling screen.

In order to shade solar radiation, the holding position of the screen 6 can be set extremely readily by pulling down the support shaft 8 at the lower end of the rolling screen 6 accommodated in the rolling screen case 4, and stopping the support shaft 8 at a desired position. The angle of the arms 9 relative to the outer wall 1 may be freely determined. However, an angle calculated according to the following formula: “The angle of the arms relative to the wall face=180 degrees−solar radiation angle×2” enables efficient solar shading.

During night or while being away from home, by moving the support shaft 8 downward until the angle of the arms relative to the wall face becomes 180 degrees, the rolling screen 6 can be pulled down to the lowest position to cover the entire window. In the case where the same pattern is printed on the rolling screen 6 and the outer wall, the rolling screen 6 fuses into the building, keeping the aesthetic appearance of the building.

When receiving wind pressure, the rolling screen 6 is risen by the wind pressure. In this case, when a tension that occurs on the rolling screen 6 due to wind and the biasing force are larger than the application force of the distal ends of the arms 9, 9′, the arms 9, 9′ rotate to pull up the rolling screen 6. When wind stops and no wind pressure is applied to the rolling screen, the rolling screen once becomes loose, but the loosen rolling screen is wound around the winding shaft 7 due to the biasing force of the biasing means. As a result of repeated blowing of weak and strong wind, the above-described process is repeated several times, and the rolling screen 6 is wound until no wind pressure is applied. For this reason, the arms 9, 9′ do not have a large load and therefore, will be durable even with a low strength, and can be manufactured at low costs.

In the case of using gear motors as the hinges, although the effect of spontaneously winding the screen by wind pressure cannot be achieved, the rolling screen can be stopped at a desired lifted position, and the lower end of the screen can be moved away from the window at the stopped position of the screen by a certain distance readily and inexpensively. Further, the position of the screen can be controlled from indoors.

The solar shading device for window according to the present invention can shade solar radiation as well as serve as an eaves in rainy weather to prevent invasion of rain even when the window is opened.

As described above, the manipulation of the solar shading device of the present invention is very simple. However, the present invention is not limited to the embodiment, and may be modified in various manners so as not to deviate from the subject matter of the present invention.

### DESCRIPTION OF REFERENCE SIGNS

1: Outer wall

2: Window opening

3: Window frame

4: Rolling screen case

5: Rolling screen case side plate

6: Rolling screen

7: Winding shaft

8: Support shaft

9, 9′: Arm

10, 10′: Torque hinge (hinge)

11: Brush

1. A solar shading device for window, comprising a rolling screen installed at an upper portion of a window on an outdoor side of a building, an upper end of the rolling screen being fixed to a winding shaft biased in a winding direction by a biasing means, and a lower end of the rolling screen being allowed to be pulled down from the winding shaft to cause the rolling screen to shade the window, wherein
the lower end of the rolling screen is supported by a support shaft,
one ends of a pair of arms are coupled to respective ends of the support shaft so as for the pair of arms to be disposed on planes perpendicular to the axis of the support shaft,
other ends of the pair of arms are fixed to respective sides of the window on the outdoor side via hinges capable of holding the arms at a desired rotational angle, the hinges being torque hinges, and
the support shaft is allowed to vertically be moved below the winding shaft to rotate the arms about the hinges along arcs having a radius equal to the length of the arms, and to cause the rolling screen to be held at a desired position so as to spring out of the window.

2. The shading device for window according to claim 1, wherein
the torque hinges are friction-type torque hinges.

3. The shading device for window according to claim 1, wherein
an application force of distal ends of the arms due to torques of the torque hinges is 1.1 to 5 times larger than a winding force acting on the rolling screen due to the biasing means.

4. The solar shading device for window according to claim 1, wherein
a cleaning element having a length equal to the width of the rolling screen is attached at a winding port of a case for accommodating the winding shaft at the upper end of the rolling screen, and is brought into contact with the rolling screen when the rolling screen is wound and unwound to remove stains adhered to the rolling screen.

5. The solar shading device for window according to claim 1, wherein
the same pattern as a pattern of an outer wall of the building is printed on the rolling screen.

6. The shading device for window according to claim 2, wherein
an application force of distal ends of the arms due to torques of the torque hinges is 1.1 to 5 times larger than a winding force acting on the rolling screen due to the biasing means.

7. The solar shading device for window according to claim 2, wherein
a cleaning element having a length equal to the width of the rolling screen is attached at a winding port of a case for accommodating the winding shaft at the upper end of the rolling screen, and is brought into contact with the rolling screen when the rolling screen is wound and unwound to remove stains adhered to the rolling screen.

8. The solar shading device for window according to claim 3, wherein
a cleaning element having a length equal to the width of the rolling screen is attached at a winding port of a case for accommodating the winding shaft at the upper end of the rolling screen, and is brought into contact with the rolling screen when the rolling screen is wound and unwound to remove stains adhered to the rolling screen.

9. The solar shading device for window according to claim 2, wherein
the same pattern as a pattern of an outer wall of the building is printed on the rolling screen.

10. The solar shading device for window according to claim 3, wherein
the same pattern as a pattern of an outer wall of the building is printed on the rolling screen.

11. The solar shading device for window according to claim 4, wherein
the same pattern as a pattern of an outer wall of the building is printed on the rolling screen.
